(19) United States
(12) Patent Application Publication
(10) Pub. No.: US 2026/0019827 A1
(43) Pub. Date: Jan. 15, 2026

(54) BASE STATION APPARATUS, CONTROL APPARATUS, CONTROL METHOD, AND COMPUTER-READABLE STORAGE MEDIUM FOR CONTROLLING REFLECTION PATTERN OF REFLECTOR

(71) Applicant: KDDI Research, Inc., Fujimino-shi (JP)

(72) Inventors: Takuya OOTO, Fujimino-shi (JP); Takahiro HAYASHI, Fujimino-shi (JP); Hiromi MATSUNO, Fujimino-shi (JP); Tatsuya NAGAO, Fujimino-shi (JP)

(21) Appl. No.: 19/333,536

(22) Filed: Sep. 19, 2025

Related U.S. Application Data
(63) Continuation of application No. PCT/JP2024/003682, filed on Feb. 5, 2024.

(30) Foreign Application Priority Data
Mar. 20, 2023 (JP) 2023-044134

(51) Int. Cl. H04W 16/26

(52) U.S. Cl. CPC H04W 16/26

(57) ABSTRACT

Abase station apparatus receives, from a control apparatus that controls a reflector that reflects radio waves transmitted from either the base station apparatus or a terminal apparatus, information indicating reflection patterns available for the reflector to reflect radio waves, determines, based on the information indicating the reflection patterns, a specific reflection pattern to be set to the reflector for communication between the base station apparatus and the terminal apparatus; and transmits, to the control apparatus, an instruction signal instructing the control apparatus to set the specific reflection pattern.

### CROSS-REFERENCE TO RELATED APPLICATION(S)

This application is a continuation of International Patent Application No. PCT/JP2024/003682 filed on Feb. 5, 2024, which claims priority to and the benefit of Japanese Patent Application No. 2023-044134 filed on Mar. 20, 2023, the entire disclosures of which are incorporated herein by reference.

### BACKGROUND OF THE INVENTION

### Field of the Invention

The present invention relates to a technology for controlling the reflection pattern of a reflector.

### Description of the Related Art

In mobile communication, wireless communication services are provided to terminal apparatuses located at positions where radio waves transmitted by a base station apparatus can be received. Therefore, it is important to ensure that the radio waves transmitted by the base station apparatus appropriately reach the positions of the terminal apparatuses. Particularly in recent wireless communication environments, which tend to use high-frequency bands, radio quality is prone to degradation. Therefore, the use of a reflector to reflect radio waves from the base station apparatus toward areas with low radio quality has been considered. In this case, the reflector can form high gain in a specific direction, thereby improving the radio quality for a specific terminal apparatus. In Takezawa, Kazuki, et al., “A Method for Estimating User Equipment Orientation Using the Ratio of Received Power due to IRS Reflection Pattern Switching”, 2022 IEEE International Symposium on Antennas and Propagation and USNC URSI Radio Science Meeting (AP S/URSI), IEEE, 2022, a technology is described in that the reflector estimates the direction of the user apparatus, using a reflection pattern for orientation estimation, and uses a reflection pattern directed toward that user apparatus.

Generally, communication between a base station apparatus and a terminal apparatus is performed under the control of the base station apparatus. Therefore, it is envisaged that the base station apparatus, when communicating with a specific terminal apparatus, transmits an instruction to the control apparatus for the reflector to use a reflection pattern with high gain in the direction of the specific terminal apparatus. However, in the technology described in Takezawa, Kazuki, et al., while the reflector can specify a reflection pattern suitable for the position of the terminal apparatus, the base station apparatus cannot specify such a reflection pattern. As a result, the base station apparatus cannot transmit an instruction to the control apparatus for the reflector to use a reflection pattern suitable for the communicating terminal apparatus, making it impossible to operate the reflector efficiently.

### SUMMARY OF THE INVENTION

The present invention provides a technology for efficiently operating a reflector capable of changing its reflection pattern.

Abase station apparatus according to one aspect of the present invention comprises: a reception unit configured to receive, from a control apparatus that controls a reflector that reflects radio waves transmitted from either the base station apparatus or a terminal apparatus, information indicating reflection patterns available for the reflector to reflect radio waves; a determination unit configured to determine, based on the information indicating the reflection patterns, a specific reflection pattern to be set to the reflector for communication between the base station apparatus and the terminal apparatus; and a transmission unit configured to transmit, to the control apparatus, an instruction signal instructing the control apparatus to set the specific reflection pattern.

A control apparatus according to one aspect of the present invention is a control apparatus for controlling a reflector that reflects radio waves transmitted from either a base station apparatus or a terminal apparatus, the control apparatus comprising: a notification unit configured to provide the base station apparatus with information indicating reflection patterns available for the reflector to reflect radio waves; a reception unit configured to receive, from the base station apparatus, an instruction signal instructing to set a specific reflection pattern to be set to the reflector for communication between the base station apparatus and the terminal apparatus; and a setting unit configured to set the specific reflection pattern to the reflector.

Other features and advantages of the present invention will be apparent from the following description taken in conjunction with the accompanying drawings. Note that the same reference numerals denote the same or like components throughout the accompanying drawings.

### BRIEF DESCRIPTION OF THE DRAWINGS

The accompanying drawings, which are incorporated in and constitute a part of the specification, illustrate embodiments of the invention and, together with the description, serve to explain principles of the invention.

FIG. 1 is a diagram illustrating an example configuration of a system;

FIG. 2 is a diagram illustrating a relationship between reflection patterns for training and reflection patterns for communication.

FIG. 3 is a diagram illustrating an example hardware configuration of an apparatus;

FIG. 4 is a diagram illustrating an example functional configuration of a base station apparatus;

FIG. 5 is a diagram illustrating an example functional configuration of a control apparatus; and

FIG. 6 is a diagram illustrating an example flow of processing executed in the system.

### DESCRIPTION OF THE EMBODIMENTS

Hereinafter, embodiments will be described in detail with reference to the attached drawings. Note, the following embodiments are not intended to limit the scope of the claimed invention, and limitation is not made to an invention that requires a combination of all features described in the embodiments. Two or more of the multiple features described in the embodiments may be combined as appropriate. Furthermore, the same reference numerals are given to the same or similar configurations, and redundant description thereof is omitted.

### Configuration of Communication System

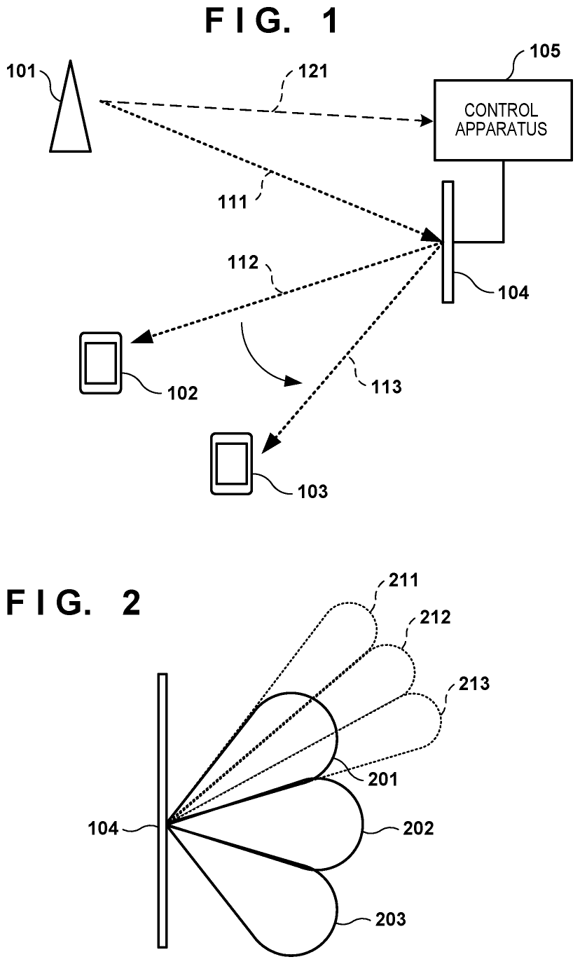

FIG. 1 shows an example configuration of a wireless communication system according to the present embodiment. The wireless communication system is, for example, a cellular communication system compliant with the 3rd Generation Partnership Project (3GPP (registered trademark)) cellular communication standards. However, the system is not limited to this, and the following discussion can be applied to a wireless communication system compliant with any wireless communication standard. The wireless communication system includes, for example, a base station apparatus 101, a terminal apparatus 102, and a terminal apparatus 103. Here, it is assumed that, due to the influence of obstructions such as buildings, the terminal apparatus 102 or the terminal apparatus 103 cannot receive radio waves transmitted from the base station apparatus 101 with sufficient power. In such cases, it is also assumed that the base station apparatus 101 cannot receive radio waves transmitted by the terminal apparatus 102 or the terminal apparatus 103 with sufficient power. In such situations, a reflector 104 may be used to enable communication between the base station apparatus 101 and the terminal apparatus 102 or the terminal apparatus 103. The reflector 104 reflects radio waves transmitted from the base station apparatus 101 with a predetermined reflection pattern. Additionally, the reflector 104 reflects radio waves transmitted from the terminal apparatus 102 with a predetermined reflection pattern. Here, each reflection pattern is determined by a reflection phase, which is set for the reflective elements constituting the reflector, and corresponds, for example, to a combination of an incident pattern and an emission pattern. Note that an incident pattern is a pattern indicating the gain of the reflector for each incident direction. In other words, a radio wave incident from a predetermined incident direction is substantially not attenuated, whereas a radio wave incident from another incident direction is attenuated to nearly zero; such a pattern is the incident pattern. Similarly, an emission pattern is a pattern indicating the gain of the reflector for each emission direction. In other words, a radio wave is emitted with high power in a predetermined emission direction, whereas hardly any radio wave is emitted in another emission direction; such a pattern is the emission pattern. Due to this reflection pattern, in general, a radio wave incident from an incident direction with high gain is output in an emission direction with high gain.

Note that the configuration in FIG. 1 is merely an example. For example, there may be two or more reflectors relaying communication between the base station apparatus 101 and the terminal apparatus 102 or the terminal apparatus 103. Additionally, it is naturally envisaged that there may be three or more terminal apparatuses. Furthermore, some terminal apparatuses may communicate via the reflector, while others may communicate directly with the base station apparatus 101 without using the reflector. Moreover, the wireless communication system may include a large number of base station apparatuses. In such cases, other base station apparatuses may also perform communication using a reflector, similar to the base station apparatus 101.

The reflector 104 is configured to be capable of changing the reflection pattern of radio waves. For example, the reflector 104 can be configured to change the reflection direction of radio waves arriving from the base station apparatus 101 or from the terminal apparatus 102 or the terminal apparatus 103 by physically controlling the orientation of the reflector. The reflector 104 is, for example, an Intelligent Reflecting Surface (IRS). In one example, the IRS may be a liquid crystal reflector. In a liquid crystal reflector, by changing the permittivity of the liquid crystal layer disposed between the reflecting elements and the ground to manipulate the impedance and change the phase of the reflecting elements, it is possible to electrically control the reflection direction of the radio waves. Note that a liquid crystal reflector is merely an example of an IRS, and other types of reflectors may be used. For example, a reflector capable of changing the phase of reflective elements using diodes or Micro Electro Mechanical Systems (MEMS) may be used. The reflector 104 is connected to a control apparatus 105. The control apparatus 105 performs control to change the reflection pattern of the reflector 104. The control apparatus 105, for example, outputs a control signal to the reflector 104 to adjust the reflection pattern of the IRS. Note that the control apparatus 105 may be an apparatus built into the reflector 104. Alternatively, the control apparatus 105 may be an apparatus provided externally to the reflector 104. Additionally, although FIG. 1 illustrates an example in which the control apparatus 105 is connected to one reflector 104, the control apparatus 105 may be connected to a plurality of reflectors. When the control apparatus 105 is connected to a plurality of reflectors, the control apparatus 105 may be configured to be capable of independently controlling the reflection pattern of each of the plurality of reflectors.

The reflection pattern of the reflector 104 is directed toward the direction where the terminal apparatus is located. Here, in Takezawa, Kazuki, et al., a technology is proposed in which the reflector 104 identifies the position of the terminal apparatus as seen from itself and sets the reflection pattern. According to this technology, a reflection pattern with high gain in the direction of the terminal apparatus is used. However, since the terminal apparatus communicating with the base station apparatus 101 is determined by the base station apparatus 101, it cannot be ensured that the reflector 104 can set a reflection pattern corresponding to the appropriate terminal apparatus. In other words, the reflection pattern of the reflector 104 may be set to have high gain in the direction of a terminal apparatus different from the terminal apparatus communicating with the base station apparatus 101. To avoid such situations, it is envisaged that the base station apparatus 101 instructs the control apparatus 105 to set a reflection pattern suitable for the communicating terminal apparatus to the reflector 104.

On the other hand, for such an instruction to be made, it is necessary for the base station apparatus 101 to know the reflection patterns that can be set by the reflector 104. In other words, if the base station apparatus 101 cannot acquire information regarding the reflection gain in each angular direction for each of the plurality of reflection patterns usable by the reflector 104, the base station apparatus 101 cannot set an appropriate reflection pattern corresponding to the position of the terminal apparatus. Additionally, while the reflector 104 can estimate the position of the terminal apparatus using reflection patterns for training, if the base station apparatus 101 does not have information regarding the reflection gain in each of the angular directions for the training reflection patterns, the base station apparatus 101 cannot recognize the direction in which the terminal apparatus is located as seen from the reflector 104. It is also envisaged that the reflection patterns for training to identify the position of the terminal apparatus are different from the reflection patterns used for communication after the completion of the training. In other words, it is envisaged that during training, the angular range in which the reflection gain is relatively high is wide, thereby allowing a single reflection pattern to be used to search for the terminal apparatus over a large area, whereas after the completion of training, the angular range in which the reflection gain is high is narrow, thereby enabling high-gain communication within a small area. In this case, even if the base station apparatus 101 has acquired information regarding the first reflection pattern for training, it is envisaged that it cannot recognize the relationship between the first reflection pattern and the second reflection pattern to be used after the completion of the training, and thus cannot select an appropriate reflection pattern after the completion of the training.

In the present embodiment, in view of such circumstances, the control apparatus 105 provides the base station apparatus 101 with information indicating the reflection patterns available to the reflector 104. The control apparatus 105 may, for example, provide the base station apparatus 101 with information regarding the reflection patterns available to the reflector 104 as part of UE Capability, which is its capability information. Note that this configuration is merely an example, and the control apparatus 105 may, for example, include that information in a message of the random access procedure when establishing a connection with the base station apparatus 101, and transmit the message. As an example, the random access preamble sequence may be associated with the available reflection patterns in advance, and the control apparatus 105 may generate a random access preamble using the sequence corresponding to the information regarding the reflection pattern to be provided. Additionally, the time and frequency resources used for transmitting the random access preamble may be associated with the available reflection patterns in advance, and the control apparatus 105 may transmit the random access preamble in the time and frequency resources corresponding to the information regarding the reflection pattern to be provided. Note that the information regarding available reflection patterns may be provided to the base station apparatus 101 based on a combination of the sequence and radio resources. Additionally, the control apparatus 105 may transmit the information regarding the reflection patterns available to the reflector 104 to the base station apparatus 101 in Message 3 of the random access procedure. Additionally, the control apparatus 105 may use uplink control information (UCI) after connection establishment, and provide the base station apparatus 101 with that information. Furthermore, if a protocol layer dedicated to the reflector is defined, that information may be provided to the base station apparatus 101 through a message in the protocol layer.

The information indicating the reflection patterns may include information regarding the reflection gain in each angular direction for each of the plurality of reflection patterns. In other words, information indicating in which direction, as seen from the reflector 104, the gain peak is directed for each of the plurality of reflection patterns is provided to the base station apparatus 101. When the base station apparatus 101 receives this information, the base station apparatus 101 can determine the reflection pattern to be set to the reflector 104 based on the positional relationship between a specific terminal apparatus (the terminal apparatus 102 or the terminal apparatus 103) and the reflector 104. In other words, the base station apparatus 101 determines a reflection pattern that forms a gain peak in the direction of that specific terminal apparatus as the reflection pattern to be used for communication with that terminal apparatus. Then, the base station apparatus 101 provides the control apparatus 105 with the determined reflection pattern, thereby setting the reflection pattern of the reflector 104. As a result, it is possible to enable the reflection pattern of the reflector 104 to be set under the control of the base station apparatus 101 so that the gain peak is directed toward the terminal apparatus communicating with the base station apparatus 101.

Note that, in this case, the base station apparatus 101 may determine the reflection pattern based on the position information regarding the terminal apparatus or the reflector 104 obtained based on the results of positioning performed by the terminal apparatus or the control apparatus 105. Here, when the terminal apparatus has not received a specific instruction from the base station apparatus 101, such as during initial connection with the base station apparatus 101, the reflector 104 may use a reflection pattern with a relatively wide angular range of high gain and a relatively low peak gain value. As a result, it is possible to deliver radio signals from the base station apparatus 101 to the terminal apparatus before initial connection with the base station apparatus 101. Note that, at this time, the radio quality of the radio signals from the base station apparatus 101 at the terminal apparatus is relatively low. Subsequently, in response to the terminal apparatus connecting with the base station apparatus 101, the position information regarding the terminal apparatus is provided to the base station apparatus 101, and the base station apparatus 101 determines the reflection pattern of the reflector 104 based on that position information and transmits, to the control apparatus 105, an instruction signal instructing the control apparatus 105 to use the determined reflection pattern. Note that the reflection pattern used here has a characteristic of a narrow angular range with relatively high gain and a high peak gain value. In other words, unlike during initial connection, the position of the terminal apparatus is identified, and therefore a reflection pattern that forms a gain peak toward the position of that terminal apparatus is used. As a result, the terminal apparatus can perform communication with the base station apparatus 101 with good radio quality.

The aforementioned reflection patterns may be defined in advance, and each may be assigned a pattern ID. As a result, the base station apparatus 101 can provide the control apparatus 105 with an instruction signal specifying a pattern ID, thereby enabling the reflector 104 to set the reflection pattern corresponding to the pattern ID.

On the other hand, the base station apparatus 101 may control the reflection pattern of the reflector 104 by providing the control apparatus 105 with information regarding the phase distribution of the reflector 104 for forming the reflection pattern of the reflector 104. In this case, the reflection pattern can be finely controlled based on the positional relationship between the reflector 104 and the terminal apparatus. In other words, when selecting a reflection pattern to use from reflection patterns defined in advance, there may be cases where a reflection pattern with a gain peak directed toward the direction where the terminal apparatus is located cannot be formed, but by using information regarding the phase distribution, a reflection pattern with a gain peak directed toward the direction where the terminal apparatus is located can be reliably formed. Note that, as information regarding the phase distribution for forming the reflection pattern, parameters of the reflector 104, including one or more of the following may be provided to the base station apparatus 101: the number of reflective elements in the reflector 104; the number of rows or columns of the array of reflective elements in the reflector 104; the spacing of the reflective elements in the reflector 104; the scattering pattern of the reflective elements in the reflector; and the granularity (resolution) of the reflection phase. Alternatively or additionally, as information regarding the phase distribution for forming the reflection pattern, a phase distribution including the phase of each of the reflective elements in the reflector 104, corresponding to a plurality of reflection patterns may be provided to the base station apparatus 101. For example, information that can individually identify a reflective element (e.g., the column number and row number in the array of reflective elements) and information indicating the phase of the reflective element are associated with each other and provided to the base station apparatus 101. Note that the phase of the reflective element may be indicated by an absolute value, or indicated by the index value corresponding to that phase if each of a plurality of phase values is associated with an index value in advance. With this information, the base station apparatus 101 can calculate and specify the reflection pattern of the reflector 104. In other words, the base station apparatus 101 can identify the positional relationship between the reflector 104 and the terminal apparatus and calculate a reflection pattern suitable for the terminal apparatus based on that positional relationship.

Note that the estimation of the position of the terminal apparatus (or the reflection pattern corresponding to that position) may be performed by setting reflection patterns for training to the reflector 104. In other words, the reflector 104 may reflect radio waves for training by using a plurality of first reflection patterns, for example, with a relatively low peak gain and a relatively wide angular range of high gain. Then, the position of the terminal apparatus is identified based on which of the plurality of first reflection patterns the terminal apparatus can receive radio waves from. Note that, in Takezawa, Kazuki, et al., the angular range with high gain is divided into a plurality of sub-ranges, and the gain is adjusted so that the power of the radio waves received by the terminal apparatus differs for each of the a plurality of sub-ranges corresponding to different areas. Then, the position of the terminal apparatus may be identified based on the received power of the radio waves at the terminal apparatus. Such first reflection patterns for training are assumed to differ from second reflection patterns used for communication after training has been completed. In other words, for communication after training has been completed, instead of the first reflection patterns with a relatively low gain peak over a wide angular range, the second reflection patterns with a high gain peak over a narrow angular range may be used.

Here, an example of the relationship between the first reflection patterns and the second reflection patterns is shown in FIG. 2. In FIG. 2, reflection patterns 201 to 203 represent reflection patterns for training. Reflection patterns 211 to 213 represent reflection patterns that are available in communications after training has been completed. Note that, in FIG. 2, the magnitude of gain is indicated by the distance from the reflector 104. In other words, the reflection patterns 201 to 203 each have a relatively low gain peak over a relatively wide angular range, while the reflection patterns 211 to 213 each have a relatively high gain peak over a relatively narrow angular range. Although FIG. 2 shows that the reflection patterns 211 to 213 for communication after training are present only for the angular range of the training reflection pattern 201, similar reflection patterns for communication after training can also be set to the reflection patterns 202 to 203. The control apparatus 105 provides the base station apparatus 101 with information regarding the reflection gain for each of the angles of the reflection patterns 201 to 203. Additionally, the control apparatus 105 may provide the base station apparatus 101 with information regarding the periods during which the reflection patterns 201 to 203 for training are set. As a result, the base station apparatus 101 can, for example, identify which of the reflection patterns for training was being used during the period in which the terminal apparatus was able to receive the radio waves, based on the timing at which the terminal apparatus received the radio waves from the base station apparatus 101 (via the reflector 104). Then, the base station apparatus 101 can identify that the terminal apparatus is located at the position corresponding to the identified reflection pattern. Additionally, for example, with the method described in Takezawa, Kazuki, et al., it is possible to identify which sub-range within the angular range corresponding to the reflection pattern for training the terminal apparatus is located in. For example, the base station apparatus 101 can identify in which direction corresponding to which sub-range of the reflection pattern 201 the terminal apparatus is located.

Here, it is assumed, for example, that the base station apparatus 101 was able to identify that the terminal apparatus is located in the first direction of the first reflection pattern 201 for training. In this case, the base station apparatus 101 may transmit an instruction signal to the control apparatus 105 to instruct the control apparatus 105 to use a second reflection pattern for communication after training, which produces a peak in that first direction. On the other hand, to enable the reflector 104 to use such a second reflection pattern, the base station apparatus 101 needs to recognize the relationship between the second reflection patterns and the first reflection patterns. In other words, even if the base station apparatus 101 can identify the first reflection pattern corresponding to the position where the terminal apparatus is located, the base station apparatus 101 cannot identify an appropriate second reflection pattern if it does not know the relationship between the first reflection patterns and the second reflection patterns. Therefore, the control apparatus 105 may provide the base station apparatus 101 with information indicating the relationship between the first reflection patterns and the second reflection patterns. The control apparatus 105 can, for example, provide the base station apparatus 101 with information indicating that the angular range of the first reflection pattern 201 includes the angular ranges of the second reflection patterns 211 to 213. Additionally, the control apparatus 105 may, for example, provide the base station apparatus 101 with information indicating, for each of the plurality of small ranges included in the angular range of the first reflection pattern 201 according to the method described in Takezawa, Kazuki, et al., which of the second reflection patterns 211 to 213 the small range corresponds to. As a result, the base station apparatus 101 can recognize the relationship between the first reflection patterns for training used to identify the direction of the terminal apparatus and the second reflection patterns used for communication with the terminal apparatus after training has been completed. Based on the relationship, the base station apparatus 101 may determine which of the second reflection patterns corresponding to the first reflection pattern used when the position of the terminal apparatus was identified, as the reflection pattern for communication with the terminal apparatus after training is complete.

Note that the base station apparatus 101 may control the reflector 104 to perform training using the second reflection patterns 211 to 213. In this case, the base station apparatus 101, for example, performs first-stage training using the first reflection patterns 201 to 203. Thereafter, when the terminal apparatus is located in the direction corresponding to the angular range of the first reflection pattern 201, the base station apparatus 101 performs second-stage training using the second reflection patterns 211 to 213 corresponding to that first reflection pattern 201. In this case, the base station apparatus 101 can recognize the correspondence between the reflection patterns to be used in the first-stage training and the reflection patterns to be used in the second-stage training based on the information provided from the control apparatus 105. Note that, if the base station apparatus 101 identifies, through the second-stage training, that the terminal apparatus is located in the direction corresponding to the angular range of the reflection pattern 212, for example, the base station apparatus 101 may determine that communications after the completion of the training is to be performed using the reflection pattern 212. However, this is merely an example, and, for example, after the completion of the second-stage training, the base station apparatus 101 may use phase distribution information to precisely calculate a reflection pattern suitable for the terminal apparatus.

Although the above example describes a case where the reflection pattern has a peak in one direction, a reflection pattern with peaks formed in a plurality of directions may also be considered. In other words, the control apparatus 105 may provide the base station apparatus 101 with not only information regarding a plurality of reflection patterns each having a peak in one direction, but also information regarding a plurality of reflection patterns with peaks formed in a plurality of directions. The information regarding reflection patterns with peaks formed in a plurality of directions may include information indicating the directions in which the peaks are formed in the reflection pattern. Additionally, in each of the above examples, the information regarding the reflection patterns may include information indicating the width of the angular range from the reflection angle at which the peak reflection gain can be obtained to the reflection angle at which the gain decreases by a predetermined level (for example, 3 dB), regardless of the number of peaks. In this case, when a plurality of terminal apparatuses are located in different directions as seen from the reflector 104, the base station apparatus 101 can select a reflection pattern to use from among reflection patterns with peaks formed in a plurality of directions, based on the positional relationship between the plurality of terminal apparatuses and the reflector 104. In other words, in an example such as that shown in FIG. 1, the base station apparatus 101 may transmit an instruction signal to the control apparatus 105 to cause the reflector 104 to use a reflection pattern with reflection gain peaks formed in the directions of both the terminal apparatus 102 and the terminal apparatus 103. As a result, for example, the base station apparatus 101 can communicate with the terminal apparatus 102 and the terminal apparatus 103 in parallel. Additionally, even when the base station apparatus 101 communicates with the terminal apparatus 102 and the terminal apparatus 103 in a time-division manner, using such reflection patterns eliminates the need to change the reflection pattern of the reflector 104. As a result, there is no response period when the reflector 104 changes the reflection pattern. As a result, the period during which communication via the reflector 104 between the base station apparatus 101 and the terminal apparatuses 102 and 103 cannot be performed is reduced, which realizes more efficient communication.

### Apparatus Configuration

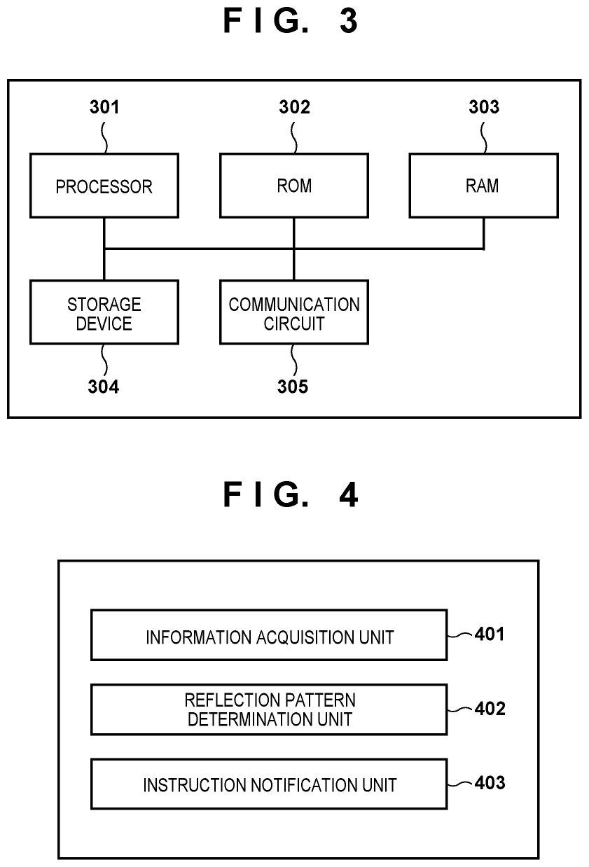

Next, an example configuration of the base station apparatus 101 and the control apparatus 105 described above will be described. Note that, in the following description, the base station apparatus 101 is referred to as the base station apparatus, and the control apparatus 105 is referred to as the control apparatus, without using reference numerals. FIG. 3 is a diagram illustrating an example hardware configuration of the base station apparatus and the control apparatus. The base station apparatus and the control apparatus each include, in one example, a processor 301, a ROM 302, a RAM 303, a storage device 304, and a communication circuit 305. The processor 301 is a computer including one or more processing circuits, such as a general-purpose CPU (Central Processing Unit) or an ASIC (Application-Specific Integrated Circuit), and performs processing regarding the entire apparatus or the above-described processing by reading and executing programs stored in the ROM 302 or the storage device 304. The ROM 302 is a read-only memory that stores programs and various parameters related to the processing executed by the base station apparatus or the control apparatus. The RAM 303 is a random access memory that functions as a workspace when the processor 301 executes programs, and that stores temporary information. The storage device 304 is constituted, for example, by a removable external storage device or the like. The communication circuit 305 includes, for example, circuits for wired or wireless communication performed by the base station apparatus or the control apparatus. For example, the base station apparatus may include circuits for wireless communication compliant with LTE or 5G for communication with the terminal apparatus 102 or the terminal apparatus 103. Note that the base station apparatus may communicate with the control apparatus using, for example, a communication circuit 305 for LTE or 5G. However, this is merely an example, and the base station apparatus may be configured to communicate with the control apparatus using a communication circuit 305 for wired or wireless communication prepared separately from the communication circuit 305 for LTE or 5G. The control apparatus includes a communication circuit 305 for wireless or wired communication to communicate with the base station apparatus. Additionally, the control apparatus may further include a communication circuit 305 for communication with the reflector (e.g., wired communication). Although one communication circuit 305 is illustrated in FIG. 3, the base station apparatus and the control apparatus may each include a plurality of communication circuits. Note that a plurality of communication functions may be implemented by a single communication circuit 305.

FIG. 4 is a diagram illustrating an example functional configuration of the base station apparatus. The base station apparatus includes, as its functions, for example, an information acquisition unit 401, a reflection pattern determination unit 402, and an instruction notification unit 403. Note that these functional units may be realized, for example, by the processor 301 executing programs stored in the ROM 302 or the storage device 304 and, as necessary, controlling the communication circuit 305. However, the present invention is not limited to such a configuration, and dedicated hardware for realizing each function may be provided, for example.

The information acquisition unit 401 acquires information indicating reflection patterns available to the reflector for radio wave reflection from the control apparatus that controls the reflector. The information indicating the reflection patterns may include, as described above, at least one of the following: information regarding the reflection gain in each angular direction for each reflection pattern; information indicating the relationship between the first reflection patterns available in training and the second reflection patterns available for communication after training; and information regarding the phase distribution of the reflector. Here, the information indicating the reflection patterns may include only patterns with a reflection gain peak in one direction or may include patterns with reflection gain peaks in a plurality of directions. Note that the information acquisition unit 401 may acquire, along with the information indicating the reflection patterns, identification information of the reflector that can use the reflection patterns. Note that, if the reflector can be identified by specifying the control apparatus, the identification information of the reflector may be the identification information of the control apparatus. Additionally, for example, when there is only one reflector in the area of the base station apparatus or when there is no need to distinguish between reflectors, the information specifying the identification information of the reflector(s) may be omitted. The information acquisition unit 401 may, for example, request the provision of UE Capability from the control apparatus, and may acquire the above-described information from the UE Capability received in response. Additionally, the information acquisition unit 401 may acquire the above-described information from Message 1 (random access preamble) or Message 3 of the random access procedure, or UCI, transmitted when the control apparatus connects to the base station apparatus. Additionally, if a protocol layer for controlling the reflector is defined, the information acquisition unit 401 may acquire the above-described information through a message in the protocol layer.

The reflection pattern determination unit 402 determines the reflection pattern to be set to the reflector for communication with the terminal apparatuses based on the information acquired by the information acquisition unit 401. For example, when the reflection pattern determination unit 402 acquires information regarding the reflection gain in each angular direction, the reflection pattern determination unit 402 selects a reflection pattern to be used for communication with the terminal apparatus from among the available reflection patterns based on that information and the positional relationship between the reflector and the terminal apparatus. Additionally, when the reflection pattern determination unit 402 receives information regarding the phase distribution for forming the reflection pattern, the reflection pattern determination unit 402 may calculate a reflection pattern suitable for the terminal apparatus using the received information based on the positional relationship between the reflector and the terminal apparatus. In other words, information indicating reflection patterns defined in advance may be provided, or information enabling the calculation of reflection patterns may be provided. Additionally, when the reflection pattern determination unit 402 receives information regarding the relationship between the first reflection patterns for training to estimate the position of the terminal apparatus as seen from the reflector and the second reflection patterns for communication after training, the reflection pattern determination unit 402 may identify the first reflection pattern corresponding to the position of the terminal apparatus, and thereafter determine that the second reflection pattern corresponding to the first reflection pattern for communication with the terminal apparatus is to be used. For example, the reflection pattern determination unit 402 may determine that a plurality of first reflection patterns for training are to be used in a time-division manner to estimate the direction in which the terminal apparatus is located as seen from the reflector. In this case, for example, based on the timing at which a radio signal from the terminal apparatus is received, it is estimated which direction corresponding to which of the plurality of first reflection patterns the terminal apparatus is located in. When the reflection pattern determination unit 402 specifies the first reflection pattern corresponding to the direction where the terminal apparatus is located through this estimation, the reflection pattern determination unit 402 may determine that one of the second reflection patterns for communication after training corresponding to the specified first reflection pattern is to be used for communication with the terminal apparatus. Note that, when the angular range corresponding to one first reflection pattern is divided into a plurality of sub-ranges, and the range of received power at the terminal apparatus of radio waves reflected from the base station apparatus is set differently for each sub-range, the base station apparatus receives a measurement report of the received power from the terminal apparatus. Then, the base station apparatus may identify which of the plurality of sub-ranges the terminal apparatus belongs to from the measurement report and select the second reflection pattern corresponding to that sub-range.

Note that the reflection pattern determination unit 402 may further determine the timing at which the reflection pattern determined to be used is to be applied. For example, when communication with a specific terminal apparatus is performed via the reflector, the reflection pattern determination unit 402 may determine the timing at which that communication is actually performed as the timing at which the setting of the reflection pattern is to be complete. Note that, when a specific reflection pattern is set semi-persistently, and there is no need to specify a timing, the timing may not be determined.

The instruction notification unit 403 transmits an instruction signal including information indicating the reflection pattern determined by the reflection pattern determination unit 402 to the control apparatus corresponding to the reflector to be controlled. For example, when settable reflection patterns are prepared in advance and each reflection pattern is assigned an index, the instruction notification unit 403 may include the index indicating the reflection pattern to be set in the instruction signal and transmit the instruction signal. Additionally, for example, when the reflection pattern is not determined in advance, the instruction notification unit 403 may provide, as the information regarding the reflection pattern to be used, parameters for realizing a specific reflection pattern of the reflector, such as the phase values to be used for the reflective elements in the reflector. Note that, when the timing at which the reflection pattern is to be set is determined, the instruction notification unit 403 may include that timing in the instruction signal and transmit the instruction signal. In addition, when it is necessary to provide information indicating the reflection pattern by specifying one of a plurality of reflectors, the instruction notification unit 403 may further include identification information that can identify that reflector in the instruction signal and transmit the instruction signal. The instruction notification unit 403 provides the control apparatus with the information indicating the reflection pattern, for example, through individual signaling.

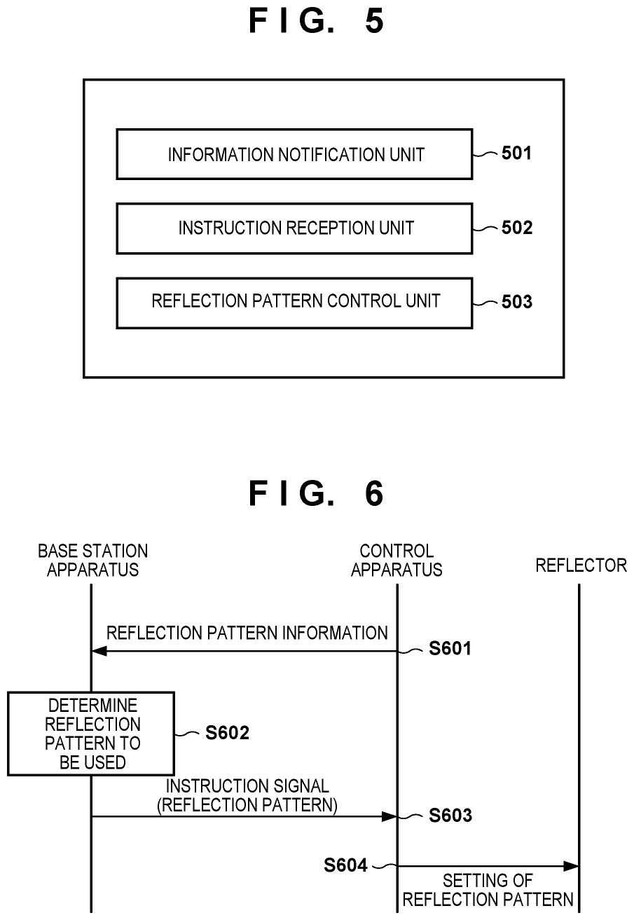

FIG. 5 is a diagram illustrating an example functional configuration of the control apparatus. The control apparatus includes, as its functions, for example, an information notification unit 501, an instruction reception unit 502, and a reflection pattern control unit 503. Note that these functional units may be realized, for example, by the processor 301 executing programs stored in the ROM 302 or the storage device 304 and, as necessary, controlling the communication circuit 305. However, the present invention is not limited to such a configuration, and dedicated hardware for realizing each function may be provided, for example.

The information notification unit 501 provides the base station apparatus with information indicating reflection patterns available to the reflector controlled by the control apparatus for radio wave reflection. The information indicating the reflection patterns is as described above and is not repeated here. The instruction reception unit 502 receives, from the base station apparatus, an instruction signal specifying the reflection pattern of the reflector. This instruction signal includes, for example, information specifying the reflection pattern to be set in the reflector and, if necessary, further includes information specifying the timing at which the reflection pattern is to be set. The reflection pattern control unit 503 sets the reflection pattern of the reflector connected to the control apparatus based on the pattern information included in the received instruction signal. Note that, when a timing is specified in the instruction signal, the reflection pattern control unit 503 may start controlling the reflector so that the setting of the reflection pattern is complete at that timing. Note that the instruction reception unit 502 may receive identification information for specifying the reflector along with the information specifying the reflection pattern. Then, when the instruction reception unit 502 receives an instruction signal including identification information corresponding to the reflector connected to the control apparatus, the instruction reception unit 502 acquires the reflection pattern information included in that instruction signal. Then, the reflection pattern control unit 503 sets the reflection pattern of the reflector based on that reflection pattern information.

### Processing Flow

Next, an example of the flow of processing executed in the wireless communication system will be explained with reference to FIG. 6. Note that, since the details of the processing have been described above, the overview of the processing flow is presented here, and the details are not repeated.

First, the control apparatus provides the base station apparatus with information regarding reflection patterns available for the reflector connected to the apparatus (5601). The base station apparatus determines the reflection pattern to be used for communication with the communicating terminal apparatus based on the provided information (5602). Then, the base station apparatus transmits, to the control apparatus, an instruction signal instructing the control apparatus to set the determined reflection pattern to the reflector (5603). The control apparatus sets the reflector to use the reflection pattern instructed in the instruction signal (5604).

As described above, in the present embodiment, the control apparatus connected to the reflector provides the base station apparatus with information regarding the reflection patterns available to that reflector. As a result, the reflection pattern of the reflector can be set under the control of the base station apparatus, which realizes efficient communication. Therefore, it is possible to contribute to Goal 9 of the Sustainable Development Goals (SDGs) led by the United Nations: “Build resilient infrastructure, promote sustainable industrialization, and foster innovation”.

The invention is not limited to the foregoing embodiments, and various variations/changes are possible within the spirit of the invention.

What is claimed is:

1. Abase station apparatus comprising:
a reception unit configured to receive, from a control apparatus that controls a reflector that reflects radio waves transmitted from either the base station apparatus or a terminal apparatus, information indicating reflection patterns available for the reflector to reflect radio waves;
a determination unit configured to determine, based on the information indicating the reflection patterns, a specific reflection pattern to be set to the reflector for communication between the base station apparatus and the terminal apparatus; and
a transmission unit configured to transmit, to the control apparatus, an instruction signal instructing the control apparatus to set the specific reflection pattern.

2. The base station apparatus according to claim 1,
wherein the information indicating the reflection patterns includes information regarding a reflection gain in each of angular directions, to which respective one of the plurality of reflection patterns corresponds, and
the determination unit determines the specific reflection pattern based on the information regarding the reflection gain in each of the angular directions and a positional relationship between the reflector and the terminal apparatus.

3. The base station apparatus according to claim 1,
wherein the information indicating the reflection patterns includes information indicating a relationship between one or more first reflection patterns available in training for estimating a direction in which the terminal apparatus is located as seen from the reflector, and a plurality of second reflection patterns available for communication between the base station apparatus and the terminal apparatus after completion of the training, and
the determination unit determines, as the specific reflection pattern, one of the second reflection patterns corresponding to one of the first reflection patterns used when the direction in which the terminal apparatus is located, as seen from the reflector, is estimated in the training.

4. The base station apparatus according to claim 1,
wherein the information indicating the reflection patterns includes information regarding a phase distribution for forming the reflection patterns of the reflector,
the information regarding the phase distribution includes at least one of (1) parameters of the reflector, including one or more of: the number of elements of the reflector; the number of rows or columns of an element array in the reflector; a spacing between the elements in the reflector; a scattering pattern of the elements in the reflector; and a reflection phase granularity, and (2) a phase distribution including a phase of each of the elements in the reflector, corresponding to a plurality of reflection patterns, and
the determination unit calculates the specific reflection pattern based on a positional relationship between the reflector and the terminal apparatus, using the information regarding the phase distribution.

5. The base station apparatus according to claim 1,
wherein the information indicating the reflection patterns includes information regarding first reflection patterns in which a gain peak occurs in one direction, and information regarding second reflection patterns in which gain peaks occur in a plurality of directions, and
when a plurality of terminal apparatuses are located in different directions as seen from the reflector, the determination unit determines, as the specific reflection pattern, one of the second reflection patterns based on a positional relationship between the plurality of terminal apparatuses and the reflector.

6. A control apparatus for controlling a reflector that reflects radio waves transmitted from either a base station apparatus or a terminal apparatus, the control apparatus comprising:
a notification unit configured to provide the base station apparatus with information indicating reflection patterns available for the reflector to reflect radio waves;
a reception unit configured to receive, from the base station apparatus, an instruction signal instructing to set a specific reflection pattern to be set to the reflector for communication between the base station apparatus and the terminal apparatus; and
a setting unit configured to set the specific reflection pattern to the reflector.

7. The control apparatus according to claim 6,
wherein the information indicating the reflection patterns includes information regarding a reflection gain in each of angular directions, to which respective one of the plurality of reflection patterns corresponds.

8. The control apparatus according to claim 6,
wherein the information indicating the reflection patterns includes information indicating a relationship between one or more first reflection patterns available in training for estimating a direction in which the terminal apparatus is located as seen from the reflector, and a plurality of second reflection patterns available for communication between the base station apparatus and the terminal apparatus after completion of the training.

9. The control apparatus according to claim 6,
wherein the information indicating the reflection patterns includes information regarding a phase distribution for forming the reflection patterns of the reflector, and
the information regarding the phase distribution includes at least one of (1) parameters of the reflector, including one or more of: the number of elements of the reflector; the number of rows or columns of an element array in the reflector; a spacing between the elements in the reflector; a scattering pattern of the elements in the reflector; and a reflection phase granularity, and (2) a phase distribution including a phase of each of the elements in the reflector, corresponding to a plurality of reflection patterns.

10. The control apparatus according to claim 6,
wherein the information indicating the reflection patterns includes information regarding first reflection patterns in which a gain peak occurs in one direction, and information regarding second reflection patterns in which gain peaks occur in a plurality of directions.

11. A control method carried out by a base station apparatus, comprising:
receiving, from a control apparatus that controls a reflector that reflects radio waves transmitted from either the base station apparatus or a terminal apparatus, information indicating reflection patterns available for the reflector to reflect radio waves;
determining, based on the information indicating the reflection patterns, a specific reflection pattern to be set to the reflector for communication between the base station apparatus and the terminal apparatus; and
transmitting, to the control apparatus, an instruction signal instructing the control apparatus to set the specific reflection pattern.

12. A control method carried out by a control apparatus for controlling a reflector that reflects radio waves transmitted from either a base station apparatus or a terminal apparatus, the control method comprising:
providing the base station apparatus with information indicating reflection patterns available for the reflector to reflect radio waves;
receiving, from the base station apparatus, an instruction signal instructing to set a specific reflection pattern to be set to the reflector for communication between the base station apparatus and the terminal apparatus; and
setting the specific reflection pattern to the reflector.

13. A non-transitory computer-readable storage medium that stores therein a program for enabling a computer provided in a base station apparatus to
receive, from a control apparatus that controls a reflector that reflects radio waves transmitted from either the base station apparatus or a terminal apparatus, information indicating reflection patterns available for the reflector to reflect radio waves;
determine, based on the information indicating the reflection patterns, a specific reflection pattern to be set to the reflector for communication between the base station apparatus and the terminal apparatus; and
transmit, to the control apparatus, an instruction signal instructing the control apparatus to set the specific reflection pattern.

14. A non-transitory computer-readable storage medium that stores therein a program for enabling a computer provided in a control apparatus for controlling a reflector that reflects radio waves transmitted from either a base station apparatus or a terminal apparatus to
provide the base station apparatus with information indicating reflection patterns available for the reflector to reflect radio waves;
receive, from the base station apparatus, an instruction signal instructing to set a specific reflection pattern to be set to the reflector for communication between the base station apparatus and the terminal apparatus; and
set the specific reflection pattern to the reflector.
